(19) United States
(12) Patent Application Publication
(10) Pub. No.: US 2013/0073460 A1
(43) Pub. Date: Mar. 21, 2013

(54) ENABLING PAID-FOR EXCHANGE OF IDENTITY ATTRIBUTES WITH MINIMAL DISCLOSURE CREDENTIALS

(71) Applicants: Christian Paquin, Redmond, WA (US); Ariel Gordon, Kirkland, WA (US); Melissa Chase, Seattle, WA (US)

(72) Inventors: Christian Paquin, Redmond, WA (US); Ariel Gordon, Kirkland, WA (US); Melissa Chase, Seattle, WA (US)

(73) Assignee: Microsoft Corporation, Redmond, WA (US)

(21) Appl. No.: 13/233,045

(22) Filed: Sep. 15, 2011

(51) Int. Cl. G06Q 40/00

(52) U.S. Cl. 705/44

(57) ABSTRACT

The claimed subject matter provides a system and method for enabling paid-for exchange of identity attributes with minimal disclosure credentials. An exemplary method includes requesting a credential from an identity provider by one of a user or a credential agent. The credential may be presented to a relying party, and the presented credential may be verified. Based on verification of the presented credential, a service of the relying party may be accessed by the user. The user, the relying party, a neutral third party, or the credential agent may provide payment for the credential to the identity provider, and the identity provider is unable to determine whether, where, when or by whom the credential has been used.

### BACKGROUND

Various transactions may be conducted online, including buying and selling products, recreational services such as online gaming, and financial services such as online banking. Such transactions typically employ some sort of cryptographic technology, such as the U-Prove technology provided by Microsoft Corporation. Some online transactions may involve verifying particular attributes of a user. For example, a user may need to prove that he or she is over the age of twenty-one to access an online casino over the internet. Similarly, a user may need to provide a certain credit score to obtain a credit card from a provider. The attributes of users are usually verified during a process that includes the service provider and the attribute provider exchanging the attribute information on behalf of the end user. This exchange can happen through back-channel calls or front channel protocol using a federated identity system.

In a federated identity system, an identity provider is a trusted entity that asserts information, or attributes, about users. As used herein, a user can be any natural person or other entity that has any associated information or data. A relying party is typically a service provider that may call for users of its services to have a particular attribute before allowing a user to have access the services. Generally, identity providers such as banks, credit bureaus, and identity brokers, expect to be compensated in some fashion for the information they deliver to or about their users.

Privacy concerns may exist regarding the federated identity systems that verify attributes of users. Traditional federated identity systems allow identity providers to track and trace the online activities of a user with ease. The traditional federated identity systems also allow relying parties to collude with identity providers in order to “compare notes” about their users. Through this collusion, identity providers and/or the relying parties can discover additional attributes about the user, or determine usage patterns that end users would rather keep private. To address these privacy concerns, privacy protecting technologies have been developed that allow users to present the attributes they select in an anonymous or pseudonymous fashion. Particularly, minimal disclosure credentials allow identity providers to issue attributes of the user in the form of a credential that can be presented to relying parties without linkability or traceability. As used herein, linkability is the ability to link various use and attribute information of a user. Thus, through minimal disclosure credentials, the identity provider and relying party are unable to collude in order to obtain additional attributes of the user. However, while the credential can be presented to relying parties without linkability or traceability, the lack of linkability and traceability may block the ability to count and audit the release of identity information that is otherwise used to enable business models based on paid-for attribute exchange. In other words, the lack of linkability and traceability may prevent the identity providers from receiving payment for providing attribute information.

### SUMMARY

The following presents a simplified summary of the innovation in order to provide a basic understanding of some aspects described herein. This summary is not an extensive overview of the claimed subject matter. It is intended to neither identify key nor critical elements of the claimed subject matter nor delineate the scope of the subject innovation. Its sole purpose is to present some concepts of the claimed subject matter in a simplified form as a prelude to the more detailed description that is presented later.

The subject innovation relates to enabling paid-for exchange of identity attributes with minimal disclosure credentials. An exemplary method requests a credential from the identity provider by one of a user, or a credential agent. The credential may be presented to a relying party, and the presented credential may be verified. Based on verification of the presented credential, a service of the relying party may be accessed by the user. The user, the relying party, or a neutral third party may provide payment for the credential to the identity provider, and the identity provider is unable to determine whether, where, when, or by whom the credential has been used.

An exemplary system relates to enabling paid-for exchange of identity attributes with minimal disclosure credentials. An exemplary system comprises a processing unit and a system memory. The system memory, which comprises a computer-readable storage medium, stores code configured to direct the processing unit to request a certified credential from the identity provider by one of a user or a credential agent. The certified credential may be protected using a storage device or a remote server. The certified credential may be presented to a relying party, and the certified presented credential may be verified. Based on verification of the certified presented credential, a service of the relying party may be accessed by the user. The user, the relying party, or a neutral third party may provide payment for the certified credential to the identity provider, and the identity provider is unable to determine whether, where, when, or by whom the credential has been used.

Another exemplary embodiment of the subject innovation provides one or more computer-readable storage media that includes code to direct the operation of a processing unit. The code may direct the processing unit to request a credential from the identity provider by one of a user or a credential agent. The credential may be presented to a relying party, and the presented credential may be verified. Based on verification of the presented credential, a service of the relying party may be accessed by the user. The user, the relying party, or a neutral third party may provide payment for the credential to the identity provider, and the identity provider is unable to determine whether, where, when, or by whom the credential has been used.

The following description and the annexed drawings set forth in detail certain illustrative aspects of the claimed subject matter. These aspects are indicative, however, of but a few of the various ways in which the principles of the innovation may be employed, and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 is a block diagram of a system that enables a paid-for exchange of identity attributes with minimal disclosure credentials according to the subject innovation;

FIG. 2 is a process flow diagram of a method that enables a paid-for exchange of identity attributes with minimal disclosure credentials according to the subject innovation;

FIG. 3 is a block diagram that enables a subscription based paid-for exchange of identity attributes with minimal disclosure credentials according to the subject innovation;

FIG. 4 is a block diagram that enables a pay-per-use exchange of identity attributes with minimal disclosure credentials according to the subject innovation;

FIG. 5 is a block diagram that that enables a pay-per-use exchange of identity attributes with minimal disclosure credentials and e-coins according to the subject innovation;

FIG. 6 is a block diagram that enables a pay per use exchange of identity attributes with minimal disclosure credentials and a credential agent according to the subject innovation;

FIG. 7 is a block diagram of an exemplary networking environment wherein aspects of the claimed subject matter can be employed; and

FIG. 8 is a block diagram of an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” and the like are intended to refer to a computer-related entity, either hardware, software (e.g., in execution), and/or firmware. For example, a component can be a process running on a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any non-transitory computer-readable device, or media, such as a computer-readable storage media.

Non-transitory computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media generally (i.e., not necessarily storage media) may additionally include communication media such as transmission media for electrical or electronic signals and the like.

Those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

The subject innovation relates to a business model for verifying user attributes with minimal disclosure credentials. Minimal disclosure credentials can be used prevent collusion between the identity provider and a relying party who has verified an attribute of the user. Typically, the other attributes that the identity provider or relying party may discover through this collusion are details that the user would want to keep private and that are unnecessary for the relying party to know.

However, privacy protections such as minimal disclosure credentials may prevent an identity provider from being compensated for providing attribute information, or credentials, of a user. The challenge in securing payment arises due to the fact that minimal disclosure credentials conceal the identity of the user and/or the relying party from the identity provider and prevents the identity provider from determining whether, where, when, or by whom the credential has been used to obtain services from a relying party. As a result, the identity provider may be unaware of who should provide payment for the credentials, or how much should be paid for the credentials.

Minimal disclosure credentials may use a cryptographic device or a cryptographic software module in order to provide an authentication factor that prevents a determination of the identity of the user and any other associated credentials. The cryptographic device or the cryptographic software module may be used in conjunction with online account for authentication, or the device or software module can be used to unlock the credentials that have been provided by the identity provider.

In other words, the credentials provided by the identity provider using minimal disclosure credentials may be likened to coins that can be spent by a user. In this scenario, a bank can serve as the “identity provider,” while a brick and mortar merchant may serve as the “relying party.” Further assume that the bank maintains a record of each user and the serial numbers of any bills they are provided when they withdraw money. Accordingly, if the user goes to the brick and mortar merchant and spends bills he received from the bank, the bank and brick and mortar merchant can easily compare records to determine the identity of the user and various unrelated credentials of the user. However, if the user spends coins at the brick and mortar merchant, the bank and brick and mortar merchant would not be able to determine the identity of the user or trace his activity, as coins have no serial numbers and no ability to be traced. Thus, minimal disclosure credentials may function like coins from the identity provider in the sense that they can be used by the user at a relying party without being tracked by the relying party or the identity provider.

Consider an online casino, where a user should be over the age of twenty-one before accessing any gambling services of the casino due to statutes governing casino operation. In order to confirm that a user is over twenty-one, an online casino would need to access a verified credential that can provide a particular attribute of the user, namely, proof of the user being over twenty-one. However, the online casino does not need to know the birth date of the user, nor does the casino need to know the age of the user. In fact, the user may wish to keep the other attributes, such as birth date and age, hidden from the casino. Typically, when visiting a brick and mortar casino, a user can prove that he is over twenty-one through a state issued identification card, such as a driver's license. In online scenarios, the state that provided the driver's license can be considered an identity provider, and the driver's license can be considered a credential.

The driver's license can be used in various “real-world” situations to prove age, such when as driving, purchasing alcohol, and visiting age restricted establishments. As used herein, the phrase “real-world” describes transactions that do not occur online. Any entity that relies on the driver's license to prove an attribute of the user can be considered a relying party. The relying party can use the driver's license to establish gender, hair color, eye color, birth date, and any other attribute of the user that appears on the face of the driver's license. However, no one entity keeps a record of every instance that the driver's license is used in order to verify an attribute of the user. In other words, neither the identity provider, nor the relying party, maintains a record that reflects each time a user has used his driver's license as a credential.

However, an online casino, as a relying party, cannot verify a driver's license as a credential. The online casino can accept credentials online that have been provided by a user in order to allow access to the online casino's services, if the casino could verify the online credentials. In this scenario, the online casino is willing to pay an identity provider to verify the user's credentials. The risk in allowing access to the casino's services is offloaded to the identity provider, who does not know anything regarding how the credential is used as a result of using minimal disclosure credentials. Further, the credential can be suited for its particular purpose, such that the credential will only provide proof of the user being at least twenty-one years of age. In this scenario, the credential will not provide exact age, date of birth, gender, or any other attributes of the user.

As another example, consider a user applying for credit online with a particular credit issuer. The credit issuer may serve as the relying party. Before allowing the user to access credit services provided by the credit issuer, the credit issuer may verify certain credentials of the user, such as the user's credit score. The user's credit score may be obtained from a credit bureau, which can be considered the identity provider. In current business models, the credit bureau and credit issuer complete a back-end transaction to exchange payment and the user's credit score. Further, the credit bureau maintains a record of when, where, and how the user has used his credit score in the past. In other words, in current business models, the identity provider will directly provide the relying party with credentials of the user without any further action from the user. Additionally, in current business models, the identity provider will keep track of when, where, and how the credential has previously been used.

In embodiments, the user may present credentials to the relying party. The user may request the credential from the identity provider, and the identity provider may charge the user for the credential. The user may run a local client, or the user may obtain credentials stored on a device. The local client may be a computer program that can obtain and store the credentials of the user on a local computer system, and the device may be a storage device, such as a removable/non-removable, volatile/non-volatile computer storage media. The relying party may present the credential to the identity provider for verification, the relying party can verify the credentials by using a key previously provided by the identity provider. Thus, a key is a means to verify user attributes with the identity provider. The relying party may also provide payment to the identity provider on a subscription basis or a pay-per-use basis.

Further, in embodiments, various mechanisms and business models allow identity providers to provide credentials using minimal disclosure credentials and collect payment for providing the credentials from a user, a relying party, a credential agent, or a neutral third party using a subscription or a per-transaction model. Further, in embodiments, the identity provider is unable to determine whether, where, when, or by whom the credentials have been used.

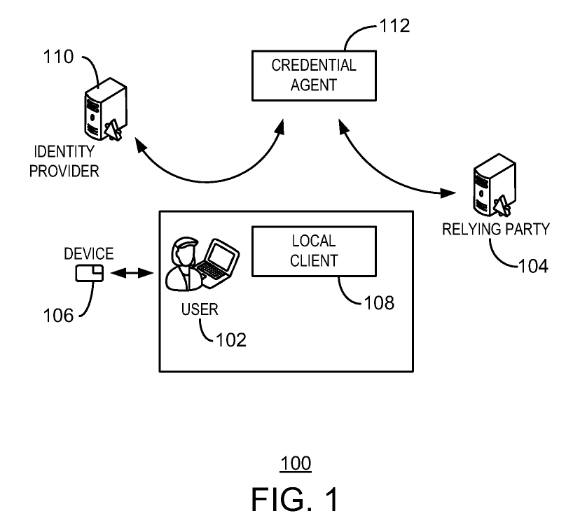

FIG. 1 is a block diagram 100 of a system that enables a paid-for exchange of identity attributes with minimal disclosure credentials according to the subject innovation. As described herein, a user 102 may be any person or entity that wishes to gain access to some service provided by a relying party 104. A relying party 104 may be a service provider that calls the user 102 of the relying party's 104 services to have a particular attribute before allowing the user 102 to access the services. The user 102 may have use a device 106 for additional security measures in communication with a local client 108. As described herein, the device 106 may be a removable/non-removable, volatile/non-volatile computer storage media, and the local client 108 may be a computer program that can obtain and store the credentials of the user on a local computer system for later use and reuse. In embodiments, the device 106 may be provided by an identity provider 110, and the device 106 may contain an authentication factor that prevents a determination of the identity of the user and any other associated credentials. Thus, the credential may be protected by the device. As described herein, an identity provider 110 is a trusted person or entity that collects information, or attributes, of users. The identity provider 110 may place various attributes about the user in the form of a credential and provide the credential to a user. The user 102 may provide the credential protected by device 106 to the relying party 104. The relying party 104 may use keys issued to it by the identity provider 110 to verify the credentials. In embodiments, the user 102 may offload the tasks of obtaining and verification of credentials to a credential agent 112.

In embodiments, the payment for the credentials may occur on a per-transaction basis, where the relying party 104 contacts the identity provider 110 to verify each credential from user 102. In other embodiments, the relying party may have a subscription with the identity provider 110 and the identity provider 110 may provide the relying party with a number of keys that can be used to verify the credential without contacting the identity provider. In embodiments, attributes within the credentials may be encrypted for a particular relying party. If the parts of the credential are encrypted, in embodiments, the credential can be used with a particular authorized relying party that has the key to unlock the contents of the credential. In embodiments, the device 106 may contain a counter that allows the user 104 to provide only a certain number of credentials from the device 106.

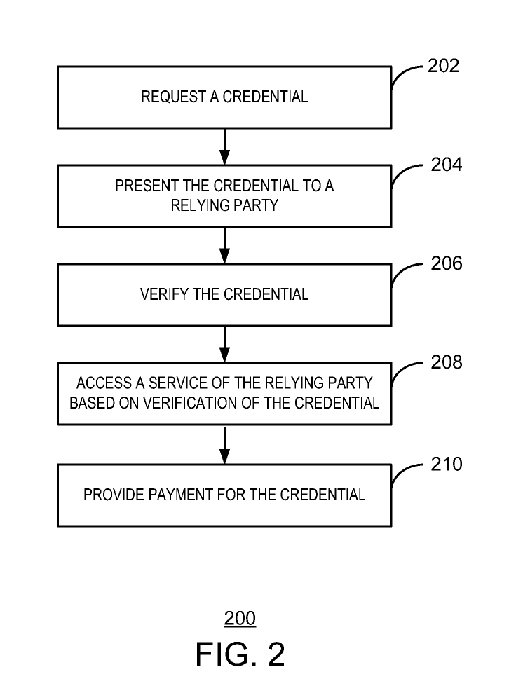

FIG. 2 is a process flow diagram 200 of a method that enables a paid-for exchange of identity attributes with minimal disclosure credentials according to the subject innovation. At block 202, a credential may be requested from an identity provider. The credential is any information or attributes regarding a user, and can be presented without disclosing unnecessary information regarding the user. The credential may be requested by one of a user or a credential agent. In embodiments, the identity provider certifies the credential, thereby providing or issuing a certified credential.

At block 204, the credential may be presented to a relying party. The credential can be presented to the relying party by any one of the user or the credential agent. In embodiments, the credential may be protected by satisfying additional security measures. Further, the credential may be presented to the relying party by satisfying additional security measures provided by a device or a remote service. At block 206, the presented credential is verified. The verification affirms that the credential is valid and was provided by the identity provider. In embodiments, the relying party may verify the credential by contacting the identity provider to ensure the credential was provided by the identity provider. In such a scenario, the minimal disclosure credential prevents the relying party from colluding with the identity provider to determine other attributes of the user. As a result, the manner in which the user has used his credentials remains private and cannot be traced or linked, meaning that neither the identity provider nor the relying party can establish a record of instances where the user has used his credentials.

At block 208, based on the verification of the presented credential, the user can access a service of the relying party. At block 210, the user, the relying party, a neutral third party, or a credential agent may provide payment for the credential to the identity provider, where the identity provider is unable to determine whether, where, when or by whom the credential has been used. Payment does not necessarily take place after presentation of the credentials. For example, in subscription models, relying parties pay in advance for unlimited access to the identity provider's attributes. In embodiments, a relying party, the neutral third party or the credential agent, may provide payment for unlimited access to a means to verify user attributes with the identity provider in advance of credential presentation. Thus, the “blocks” described herein do not imply any particular order within the process flow diagram 200.

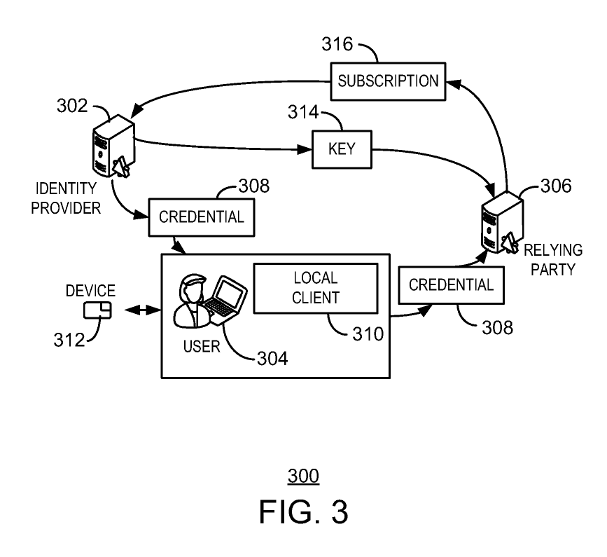

FIG. 3 is a block diagram 300 that enables a subscription based paid-for exchange of identity attributes with minimal disclosure credentials according to the subject innovation. In this model, the relying party may have a subscription with the identity provider and the identity provider can provide a number of keys to the relying party that are used to verify a presented credential. In embodiments, the relying party may have a subscription with the credential agent, which in turn, may have a subscription with one or more identity providers, and the credential agent can provide a number of keys to the relying party that are used to verify a presented credential.

The diagram 300 includes an identity provider 302, a user 304, and a relying party 306. The user 304 may request a credential 308 from the identity provider 302, and the credential may be stored by local client 310 for later use and reuse. The user may or may not provide payment for the credential 308 to the identity provider 302. In embodiments, the credential 308 may be protected by a device 312. The device 312 may be obtained from the identity provider 302, the relying party 306, or another entity such as a retailer. Regardless of whether the credential 308 is protected by the device 312, the credential 308 is provided as a minimal disclosure credential as described herein, thereby eliminating the possibility that the identity provider 302 can track the usage of the credential 308.

The credential 308 may be presented to the relying party 306 by the user 304 from the local client 310. The relying party 306 may verify the credential 308 using a key 314. The relying party 306 may obtain the key 314 from the identity provider 302 by providing the identity provider with a subscription 316. The subscription is a payment for any time period, such as one month, six months, or one year, in exchange for keys that the relying party can use to verify credentials received from the user. When the relying party 306 provides the identity provider with the subscription 316, the identity provider 302 provides the relying party 306 with keys 314 during the time period of the subscription 316.

The subscription may be unlimited, meaning that the relying party can be supplied with an unlimited number of keys during the time period of subscription. For security purposes, the keys may change on a regular basis. The credentials may also be short-lived, meaning that they expire after a certain period of time. Additionally, the identity provider can encrypt the credential to maintain a high level of control over the information contained in the credential. The encryption may also limit the scope of use of the credential, meaning that the credential can only be used provide information to a particular relying party because no other relying party's key is able to verify the credential. However, since the credential was obtained using minimal disclosure credentials, the identity provider does not know whether, where, when, or by whom the credential is used, even when the credential has been encrypted.

Thus, in a subscription based model, the relying party can pay an unlimited subscription fee to the identity provider in exchange for the ability to verify user presented credentials. When the subscription ends, the relying party is no longer capable of verifying presented credentials. Further, the identity provider can change the key at every subscription period, and the relying party may receive updated keys in order to verify the presented credentials.

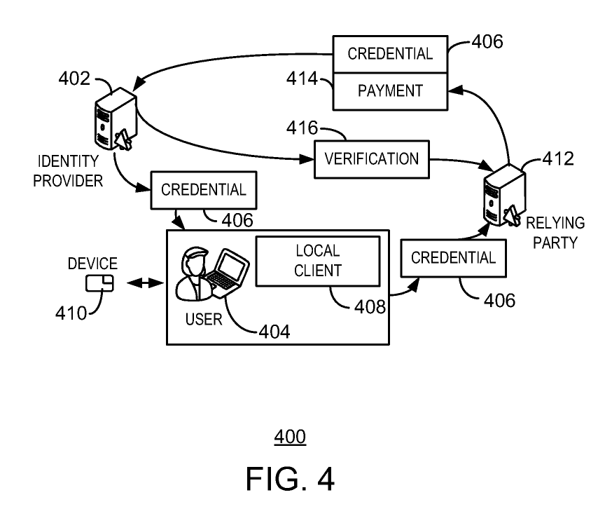

FIG. 4 is a block diagram 400 that enables a pay-per-use exchange of identity attributes with minimal disclosure credentials according to the subject innovation. In this model, the relying party may present the credential to the identity provider for verification, and the relying party may provide payment to the identity provider for each verification.

The user 404 may request a credential 406 from the identity provider 402, and the credential 406 may be stored by local client 408 for later use and reuse. The user may or may not provide payment for the credential 406 to the identity provider 402. In embodiments, the credential 406 may be protected by a device 410. The device 410 may be obtained from the identity provider 402, the relying party 412, or another entity such as a retailer. Regardless of whether or not the credential 406 is protected by the device 410, the credential 406 is provided as a minimal disclosure credential as described herein, thereby eliminating the possibility that the identity provider 402 can track the usage of the credential 406.

The credential 406 may be presented to the relying party 412 by the user 404. The relying party 412 may present the credential 406 and a payment 414 to the identity provider 402. Upon receipt of the credential 406 and the payment 414, the identity provider 402 may verify the credential 406 and send a verification 416 to the relying party 412. Thus, in this model, the relying party 412 does not verify the credential 406. Rather, the relying party 412 contacts the identity provider 402 for verification 416 of each presented credential 406. Again, minimal disclosure technologies can be used to prevent the relying party 412 from colluding with the identity provider 402 to determine other attributes of the user 404, including the identity of the user. As a result, the manner in which the user 404 has used his credentials remains private.

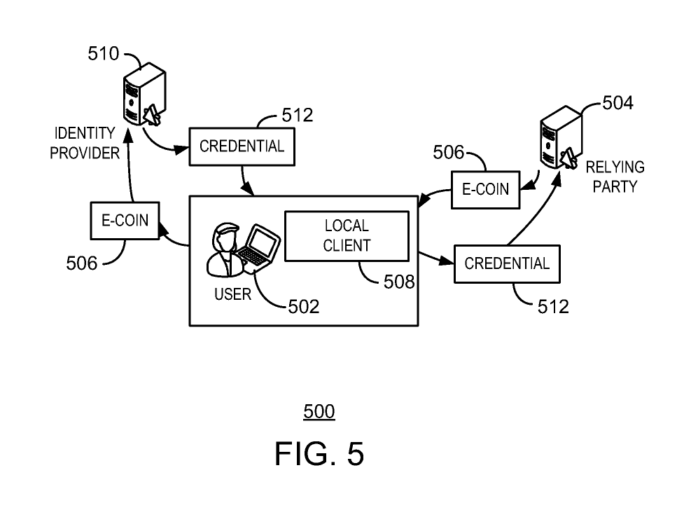

FIG. 5 is a block diagram 500 that that enables a pay-per-use exchange of identity attributes with minimal disclosure credentials and e-coins according to the subject innovation. In this model, the relying party may provide payment to the user when the relying party makes its access policy known to the user. The user may forward this payment to the identity provider, in the form of an e-coin. If the e-coin is unlinkable, meaning that the e-coin is encoded as a minimal disclosure credential, the identity provider cannot learn the identity of the relying party.

The user 502 may contact a relying party 504 in order to determine the access policy of the relying party, which may include a definition of the credentials needed to access services provided by the relying party. The relying party may provide a form of payment to the user, along with a definition of credentials needed to access services provided by the relying party. The payment and definition of credentials needed to access services provided by the relying party may be referred to as an electronic coin, or e-coin 506, and may be stored on the local client 508 for later use. Thus, one or more e-coins 506 may be requested from the relying party. The user 502 may present the one or more e-coins 506 to the identity provider 510 in order to obtain a credential 512. Although not shown, the user 502 may also present the one or more e-coins 506 to a credential agent in order to obtain a credential 512. The identity provider 510 or the credential agent may send a credential 512 to the user 502 in response to receiving the e-coin 506. The credential 512 may be stored by local client 508 for later use and reuse. The user 502 can present the credential 512 to the relying party 504 to access the services of the relying party 504. The e-coin 506 is similar in nature to coins used to purchase items, or access services, of a brick and mortar merchant as described herein. The credentials provided based on the receipt of an e-coin may be provided using a minimal disclosure credential described herein, thereby eliminating the possibility that the identity provider 510 can track the usage of the credential 512.

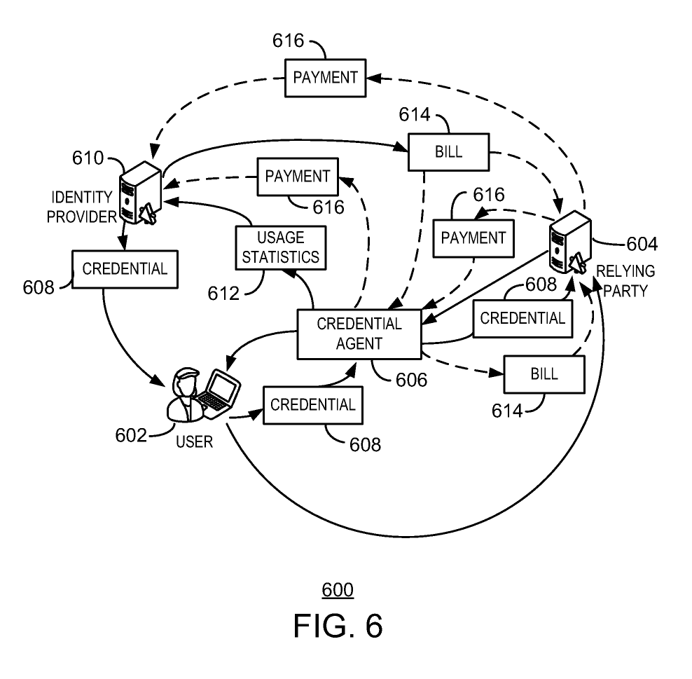

FIG. 6 is a block diagram 600 that enables a pay per use exchange of identity attributes with minimal disclosure credentials and a credential agent according to the subject innovation. The user 602 may attempt to access services of a relying party 604. In response, the relying party 604, may contact a credential agent 606 in order to verify the attributes of the user. A credential agent is a service that acts on behalf of users, replacing the local client. The credential agent 606 may then guide the user in retrieving a credential 608 from an identity provider 610.

The credential 608 may be issued to the credential agent 606 and presented to the relying party 604 by the credential agent 606 acting on behalf of the user 602. Periodically, the credential agent 606 may provide usage statistics 612 to the identity provider 610 in order for the identity provider to request payment from the relying party. Again, minimal disclosure credentials prevent the relying party 604 from colluding with the identity provider 610 to determine other attributes of the user 602. As a result, the manner in which the user 602 has used his credentials remains private, meaning that neither the identity provider nor the relying party 604 can establish a record of instances where the user has used his credentials. Based on the usage statistics 612 from the credential agent 606, the identity provider 610 may send a bill 614 to the relying party 604 or to the credential agent 606, as noted by dashed lines to the relying party 604 or to the credential agent 606. When the bill 614 is sent to the credential agent 606, the credential agent 606 may send the bill 614 to the relying party 604 for the number of credentials presented by the relying party 604 within a billing period. The relying party 604 then remits payment 616 to the identity provider 610 or to the credential agent 606. When the payment 616 is remitted to the credential agent 606, the credential agent 606 may then forward the payment 616 to the identity provider 610. Thus, in embodiments, the relying party 604 pays the identity provider 610 directly, in which case the credential agent 606 is merely a protocol intermediary. Further, in embodiments, the relying party 604 pays the credential agent 606, which in turns pays the identity provider 610.

For example, consider a cloud hosted credential agent, and a cloud-hosted casino as a relying party. As used herein, the cloud refers to computing services are accessible in an internet data center. The cloud hosted casino may ask the cloud hosted credential agent if the user is at least twenty-one years old. The cloud hosted credential agent may then guide the user into retrieving a proof-of-age credential from an identity provider such as the user's bank. The payment between the cloud hosted credential agent and the identity provider could be made as a part of cloud hosting fees.

The credential agent can be used in various models, including the subscription based business model for an identity provider with minimal disclosure credentials of FIG. 3. For example, the credential agent can be paid by the relying party on a subscription basis as described herein in regards to FIG. 3. Additionally, the credential agent could remit payment to the identity provider on a per transaction basis, as in FIG. 4.

In embodiments, a user may present the credential after it has been protected by a device, such as device 106, device 312, or a device 410. Thus, the user may present the credential to the relying party by satisfying additional security measures, which may be provided by a device or a remote service. The device may contain a counter, and may be pre-paid by the user or the relying party. The counter can limit the number of transactions the device can participate in, up to the value of the counter. The device may also limit credentials to be presented to authorized relying parties.

Further, in embodiments, a relying party or credential agent may report the credentials that have been presented to the relying party to a neutral third party, such as a clearinghouse. The credential agent may also report usage statistics to the neutral third party. The neutral third party can receive payment for the reported credentials from the relying party or the credential agent based on the usage statistics. The neutral third party may also distribute payment to one or more identity providers. The distribution of payments to the identity provider could be based on the usage statistics reported by a credential agent. The neutral third party may also use a statistically representative sample of end users that choose to allow linkage between issuance and presentation of the credentials. The neutral third party can use those statistics to determine how to split the aggregated revenues between multiple identity providers.

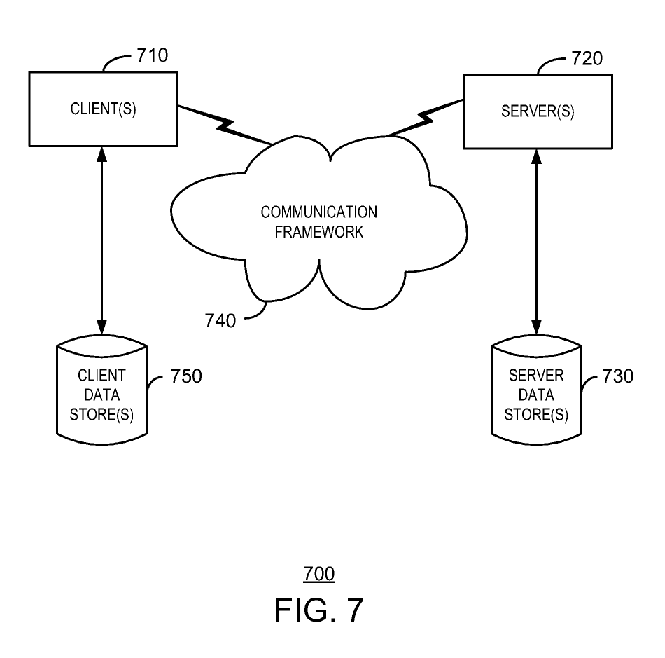

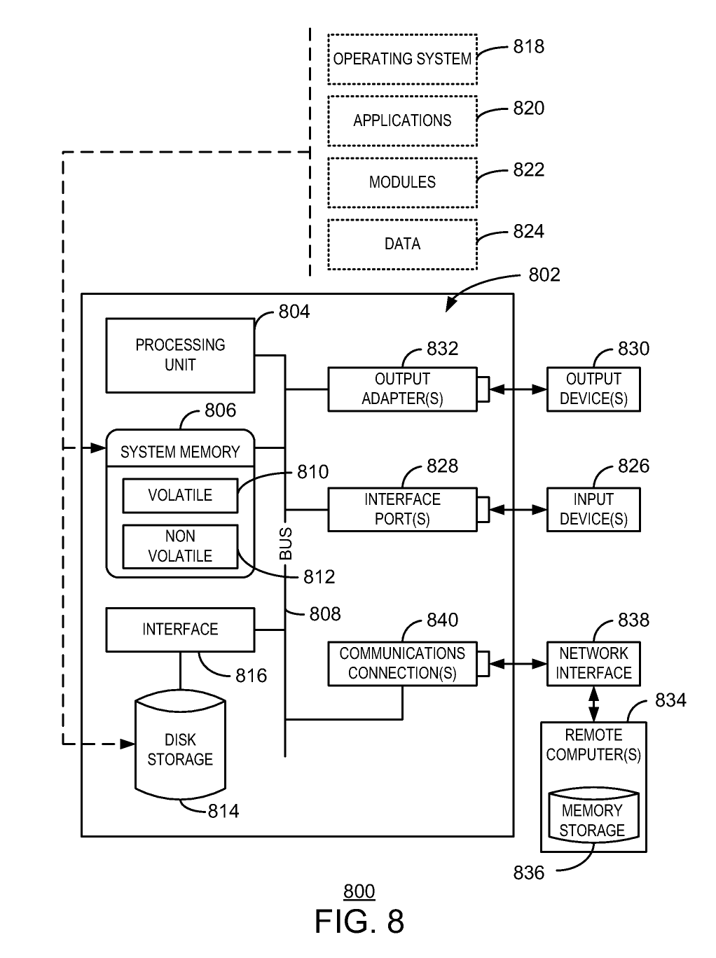

In order to provide additional context for implementing various aspects of the claimed subject matter, FIGS. 7-8 and the following discussion are intended to provide a brief, general description of a suitable computing environment in which the various aspects of the subject innovation may be implemented. For example, enabling paid-for exchanges of identity attributes with minimal disclosure credentials, as described in FIGS. 2-6, can be implemented in such a computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the subject innovation may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 7 is a schematic block diagram of a sample-computing system 700 with which a business models for an identity provider with minimal disclosure credentials can be implemented. The system 700 includes one or more client(s) 710. The client(s) 710 can be hardware and/or software (e.g., threads, processes, computing devices). The system 700 also includes one or more server(s) 720. The server(s) 720 can be hardware and/or software (e.g., threads, processes, computing devices).

A client 710 may be a user computer that contains a local client that is able to obtain and store credentials of the user for later use and reuse. A server 720 can represent a relying party, an identity provider, a credential agent, or a neutral third party. The system 700 includes a communication framework 740 that can be employed to facilitate communications between the client(s) 708 and the server(s) 720. The client(s) 710 are operably connected to one or more client data store(s) 750 that can be employed to store information local to the client(s) 710. The client data store(s) 750 do not have to be in the client(s) 710, but may be located remotely, such as in a cloud server. Similarly, the server(s) 720 are operably connected to one or more server data store(s) 730 that can be employed to store information local to the servers 720. As an example, a client data store 750 can be used to store the local client that is able to obtain and store credentials of the user. A server data store 730 may be used to store credentials of various users.

With reference to FIG. 8, an exemplary environment 800 for implementing various aspects of the claimed subject matter includes a computer 802. The computer 802 includes a processing unit 804, a system memory 806, and a system bus 808. The system bus 808 couples system components including, but not limited to, the system memory 806 to the processing unit 804. The processing unit 804 can be any of various available processors. Dual microprocessors and other multiprocessor architectures also can be employed as the processing unit 804. The system bus 808 can be any of several types of bus structure(s) including the memory bus or memory controller, a peripheral bus or external bus, and/or a local bus using any variety of available bus architectures known to those of ordinary skill in the art.

The system memory 806 may include non-transitory computer-readable storage media comprising volatile memory 810 and nonvolatile memory 812. The basic input/output system (BIOS), containing the basic routines to transfer information between elements within the computer 802, such as during start-up, is stored in nonvolatile memory 812. By way of illustration, and not limitation, nonvolatile memory 812 can include read only memory (ROM), programmable ROM (PROM), electrically programmable ROM (EPROM), electrically erasable programmable ROM (EEPROM), or flash memory.

Volatile memory 810 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computer 802 also includes other non-transitory computer-readable media, such as removable/non-removable, volatile/non-volatile computer storage media. FIG. 8 shows, for example a disk storage 814. Disk storage 814 includes, but is not limited to, devices like a magnetic disk drive, floppy disk drive, tape drive, Jaz drive, Zip drive, LS-100 drive, flash memory card, or memory stick.

In addition, disk storage 814 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 814 to the system bus 808, a removable or non-removable interface is typically used such as interface 816.

It is to be appreciated that FIG. 8 describes software that acts as an intermediary between users and the basic computer resources described in the suitable operating environment 800. Such software includes an operating system 818. Operating system 818, which can be stored on disk storage 814, acts to control and allocate resources of the computer 802.

System applications 820 take advantage of the management of resources by operating system 818 through program modules 822 and program data 824 stored either in system memory 806 or on disk storage 814. It is to be appreciated that the local client can be implemented with various operating systems or combinations of operating systems. In embodiments, the local client may be a program module 822.

A user enters commands or information into the computer 802 through input device(s) 826. Input devices 826 include, but are not limited to, a pointing device (such as a mouse, trackball, stylus, or the like), a keyboard, a microphone, a joystick, a satellite dish, a scanner, a TV tuner card, a digital camera, a digital video camera, a web camera, and/or the like. The input devices 826 connect to the processing unit 804 through the system bus 808 via interface port(s) 828. Interface port(s) 828 include, for example, a serial port, a parallel port, a game port, and a universal serial bus (USB).

Output device(s) 830 use some of the same type of ports as input device(s) 826. Thus, for example, a USB port may be used to provide input to the computer 802 and to output information from computer 802 to an output device 830. Information rendered by the subject innovation may appear on an output device 830.

Output adapter 832 is provided to illustrate that there are some output devices 830 like monitors, speakers, and printers, among other output devices 830, which are accessible via adapters. The output adapters 832 include, by way of illustration and not limitation, video and sound cards that provide a means of connection between the output device 830 and the system bus 808. It can be noted that other devices and/or systems of devices provide both input and output capabilities such as remote computer(s) 834.

The computer 802 can be an identity provider in a networked environment using logical connections to one or more remote computers, such as remote computer(s) 834. The remote computers can be a user computer, a relying party, a credential agent, or a neutral third party. The remote computer(s) 834 may be client systems configured with web browsers, PC applications, mobile phone applications, and the like, to allow users to browse the Internet, as discussed herein. The remote computer(s) 834 can be a personal computer, a server, a router, a network PC, a workstation, a microprocessor based appliance, a mobile phone, a peer device or other common network node and the like, and typically includes many or all of the elements described relative to the computer 802. For purposes of brevity, only a memory storage device 836 is illustrated with remote computer(s) 834. However, external storage devices, such as memory sticks, can be used with remote computer(s) 834. Further, remote computer(s) 834 is logically connected to the computer 802 through a network interface 838 and then physically connected via a communication connection 840.

Network interface 838 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Credential Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 840 refers to the hardware/software employed to connect the network interface 838 to the bus 808. While communication connection 840 is shown for illustrative clarity inside computer 802, it can also be external to the computer 802. The hardware/software for connection to the network interface 838 may include, for exemplary purposes only, internal and external technologies such as, mobile phone switches, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and/or events of the various methods of the claimed subject matter.

There are multiple ways of implementing the subject innovation, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the subject innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A method for enabling paid-for exchange of identity attributes with minimal disclosure credentials, comprising:
requesting a credential from an identity provider by one of a user or a credential agent;
presenting the credential to the relying party;
verifying the presented credential;
accessing a service of the relying party by the user based on verification of the presented credential; and
providing payment from the user, the relying party, a neutral third party, or the credential agent for the credential to the identity provider, wherein the identity provider is unable to determine whether, where, when or by whom the credential has been used.

2. The method recited in claim 1, wherein the relying party has a subscription with the identity provider and the identity provider provides a number of keys to the relying party that are used to verify a presented credential.

3. The method recited in claim 1, wherein the relying party presents the credential to the identity provider for verification, and the relying party provides payment to the identity provider for each verification.

4. The method recited in claim 1, comprising presenting the credential to the relying party by satisfying additional security measures provided by a device or a remote service.

5. The method recited in claim 1, wherein the credential agent provides usage statistics to the identity provider in order for the identity provider to request payment from the relying party.

6. The method recited in claim 1, comprising;
requesting one or more e-coins from the relying party; and
presenting one or more e-coins to the identity provider or the credential agent in order to obtain the credential.

7. The method recited in claim 1, wherein the user requests the credential from the identity provider, and the identity provider charges the user for the credential.

8. The method recited in claim 1, wherein the credential agent reports usage statistics to the neutral third party, and the neutral third party receives payment from the relying party or the credential agent based on the usage statistics and distributes the payment to one or more identity providers.

9. A system that enables a paid-for exchange of identity attributes with minimal disclosure credentials, the system comprising:
a processing unit; and
a system memory, wherein the system memory comprises code configured to direct the processing unit to:
request a certified credential from an identity provider by one of a user or a credential agent;
protect the certified credential using a storage device or a remote server;
present the certified credential to the relying party;
verifying the certified presented credential;
access a service of the relying party by the user based on verification of the certified presented credential; and
provide payment from the user, relying party, a neutral third party, or the credential agent for the credential to the identity provider, wherein the identity provider is unable to determine whether, where, when or by whom the credential has been used.

10. The system recited in claim 9, comprising a counter on the storage device that limits the number of times credentials can be presented to a relying party.

11. The system recited in claim 9, wherein the relying party has a subscription with the identity provider and the identity provider provides a number of keys to the relying party that are used to verify a certified, presented credential

12. The system recited in claim 9, wherein the relying party presents the certified credential to the identity provider for verification, and the relying party provides payment to the identity provider for each verification.

13. The system recited in claim 9, wherein the credential agent provides usage statistics to the identity provider in order for the identity provider to request payment from the relying party.

14. The system recited in claim 9, comprising issuing the credential to the credential agent, and the credential agent presenting the credential to the relying party on behalf of the user.

15. One or more computer-readable storage media, comprising code configured to direct a processing unit to:
request a credential from the identity provider by one of a user or a credential agent;
present the credential to the relying party;
verify the presented credential;
access a service of the relying party by the user based on verification of the presented credential; and
providing payment from the user, relying party, a neutral third party, or the credential agent for the credential to the identity provider, wherein the identity provider is unable to determine whether, where, when, or by whom the credential has been used.

16. The one or more computer-readable storage media recited in claim 15, wherein the relying party has a subscription with the identity provider and the identity provider provides a number of keys to the relying party that are used to verify a presented credential.

17. The one or more computer-readable storage media recited in claim 15, wherein the relying party presents the credential to the identity provider for verification, and the relying party provides payment to the identity provider for each verification.

18. The one or more computer-readable storage media recited in claim 15, wherein the credential agent provides usage statistics to the identity provider in order to request payment from the relying party.

19. The one or more computer-readable storage media recited in claim 15, comprising:
requesting one or more e-coins from the relying party; and
presenting the one or more e-coins to the identity provider and or the credential agent in order to obtain the credential.

20. The one or more computer-readable storage media recited in claim 15, wherein the credential agent reports usage statistics to the neutral third party, and the neutral third party receives payment from the relying party or the credential agent based on the usage statistics and distributes the payment to the identity provider.
